(19) United States
(12) Patent Application Publication
(10) Pub. No.: US 2025/0020118 A1
(43) Pub. Date: Jan. 16, 2025

(54) CABLE STRINGING ASSEMBLY HAVING ELECTRIC AIR MOVING DEVICE AND METHODS THERETO

(71) Applicant: Sherman + Reilly, Inc., Chattanooga, TN (US)

(72) Inventors: Douglas Bruce MacDonald, Dawsonville, GA (US); Toni Corinne Tran, Chattanooga, TN (US); Timothy Michael Hanson, Chattanooga, TN (US)

(21) Appl. No.: 18/768,312

(22) Filed: Jul. 10, 2024

Related U.S. Application Data
(60) Provisional application No. 63/513,099, filed on Jul. 11, 2023.

(51) Int. Cl. F04B 49/20; F04B 49/06

(52) U.S. Cl. CPC F04B 49/20; F04B 49/06; F04B 2205/16

(57) ABSTRACT

The disclosed technology includes an air moving system for a stringing apparatus. The air moving system can comprise an energy bank, an electric air moving device in electrical communication with the energy bank and configured to output a supply of air to cause a cable to move along a duct and at least one controller. The at least one controller can be configured to determine a speed of the cable moving along the duct and control the output of the supply of air of the electric air moving device to control the speed of the cable based at least in part on the determined speed of the cable.

### CROSS-REFERENCE TO RELATED APPLICATIONS

This application claims the benefit, under 35 U.S.C. § 119 (c), of U.S. Provisional Patent Application No. 63/513,099, filed 11 Jul. 2023, the entire contents and substance of which are incorporated herein by reference in their entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The invention is in the field of cable stringing apparatuses and methods, and, more particularly, to underground cable stringing apparatuses and methods.

### 2. Description of Related Art

High voltage utility transmission lines can transmit power over hundreds of miles with minimal losses because of the very high voltages used. These high voltage utility transmission lines are installed in both overhead and underground systems. Stringing high-voltage conductor lines across significant distances requires the use of conductor stringing apparatuses. The installation of power transmission lines and communication lines, sometimes referred to as “pulling conductors”, or “tension stringing” utilizes a number of components spread over a wide area. A device called a conductor or cable puller-tensioner is used, although those of skill in the art know that other terms are used for this equipment. The equipment is typically termed by what it does.

For underground stringing applications, special stringing equipment is used to push a bird (also referred to as a torpedo, pig, mouse, etc.) connected to an end of a cable (or rope) through an underground duct using a supply of air. This operation is sometimes referred to as a “blowing” operation because the air is used to blow the cable through the duct to reach the other end of the duct. Once at the opposite end of the duct, the cable is attached to a conductor (such as utility lines, fiber optic cables, and the like) and pulled back through the duct to complete the installation of the conductor. Generally, a reel (spool, wheel, drum, etc.) is positioned at the opposite end of the duct and the conductor is pulled off the reel and into the duct.

Existing underground stringing equipment generally include an internal combustion engine configured to power hydraulic systems and the air compressor, which can limit the applications where the air compressor is used. Furthermore, the air compressors currently used are designed to only output air from the air compressor at a single, full-capacity, flow rate. Thus, when the bird becomes stuck in the duct, the cable and bird must be pulled back out or additional air pressure must be applied by a vacuum placed at the opposite end of the duct or by an additional or larger air compressor system. This requires additional equipment which increases cost and time required to complete the installation.

Accordingly, there is a need it the art for improved underground stringing apparatuses capable of controlling a delivery of air to the duct through a range of flow rates to complete the stringing installation in a more efficient and effective manner. Furthermore, it is desirable to augment power supplied conventionally only by internal combustion engines/generators if not remove completely the dependence upon internal combustion engines in underground stringing applications. Aspects of the disclosed technology address these and other issues.

### BRIEF SUMMARY OF THE INVENTION

The disclosed technology includes an air moving system for a stringing apparatus. The air moving system can include an energy bank, an electric air moving device in electrical communication with the energy bank and configured to output a supply of air to cause a cable to move along a duct, and at least one controller. The at least one controller can be configured to determine a speed of the cable moving along the duct and control the output of the supply of air of the electric air moving device to control the speed of the cable based at least in part on the determined speed of the cable.

The disclosed technology can further include stringing apparatus comprising an energy bank, a driveline in electrical communication with the energy bank and configured to receive or to deliver a cable, an electric air moving device in electrical communication with the energy bank and configured to output a supply of air, and at least one controller. The at least one controller can be configured to determine a speed of a cable being delivered from the driveline and control the output of the supply of air of the electric air moving device to control the speed of the cable based at least in part on the determined speed of the cable.

These and other objects, features and advantages of the disclosed technology will become more apparent upon reading the following specification in conjunction with the accompanying drawing figures.

### BRIEF DESCRIPTION OF THE DRAWINGS

The accompanying figures, which are incorporated in and constitute a part of this specification, illustrate several aspects described below.

FIGS. 1 and 2 depict an underground stringing apparatus, duct, and reel, in accordance with the disclosed technology.

FIG. 3A is a first perspective view of an underground stringing apparatus, in accordance with the disclosed technology.

FIG. 3B is a second perspective view of an underground stringing apparatus, in accordance with the disclosed technology.

FIG. 3C is a top view of an underground stringing apparatus, in accordance with the disclosed technology.

FIGS. 3D and 3E are side views of an underground stringing apparatus, in accordance with the disclosed technology.

FIG. 4A is a block diagram of an example control system of an underground stringing apparatus, in accordance with the disclosed technology.

FIG. 4B is a block diagram of an example stand-alone unit, in accordance with the disclosed technology.

FIG. 5 is a flowchart of an example method of installing an underground cable, in accordance with the disclosed technology.

FIG. 6 is a flowchart of an example method of installing an underground cable, in accordance with the disclosed technology.

### DETAILED DESCRIPTION OF THE INVENTION

To facilitate an understanding of the principles and features of the various examples of the invention, various illustrative embodiments are explained below. Although examples of the invention are explained in detail, it is to be understood that other examples are contemplated. Accordingly, it is not intended that the invention is limited in its scope to the details of construction and arrangement of components set forth in the following description or illustrated in the drawings. The invention is capable of other examples and of being practiced or carried out in various ways. Also, in describing the examples, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Furthermore, although the various methods may be shown and described herein as having a particular order, it will be appreciated by one of skill in the art that the method steps shown and described can be rearranged in various other orders without departing from the scope of this disclosure. Similarly, it is also to be understood that the mention of one or more components in a composition does not preclude the presence of additional components than those expressly identified.

Examples of the disclosed technology can include underground stringing equipment for stringing wires, pulling lines, ropes, cables, cords, and the like (collectively, “cables”) through underground ducts. The underground stringing equipment can include a battery bank, a capacitor bank, or both (“energy bank”) configured to provide power to a hydraulic system and to an air moving device. The air moving device can be configured to vary its output to affect the pressure and flowrate of the air to control a speed at which a cable is moved through a duct. The energy bank can further provide power to a levelwind and a reel configured to pull a cable back through the duct to install the cable. The underground stringing equipment can further comprise an engine coupled to a generator, which can charge the energy bank to ensure sufficient power is available to complete the installation.

Examples of the present disclosure may include additional energy sources and stores. For example, the system can be adapted to receive power from an external power source (e.g., by plugging into an external generator or the power grid). The external power can include additional energy banks that can be connected to the underground stringing equipment to charge the onboard energy bank or to provide additional power to the underground stringing equipment during a blowing or pulling operation.

For case of explanation, the system is discussed below with reference to stringing underground power and communications lines. One of skill in the art will recognize, however, that the system is not so limited. Indeed, the system could be used in any number of industries where ropes, cables, wires, and other similar products need to be efficiently installed through a duct, whether above or below ground. Thus, the description below is intended to be illustrative and not limiting.

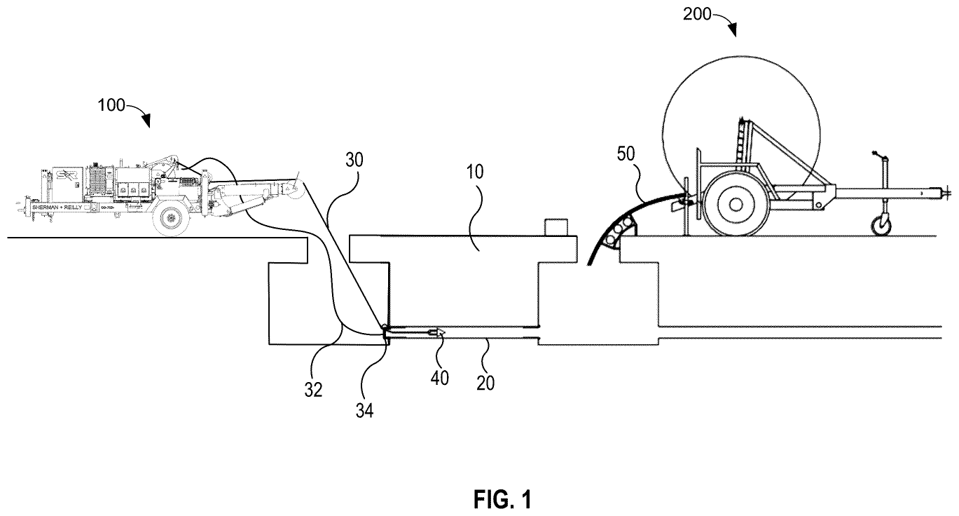

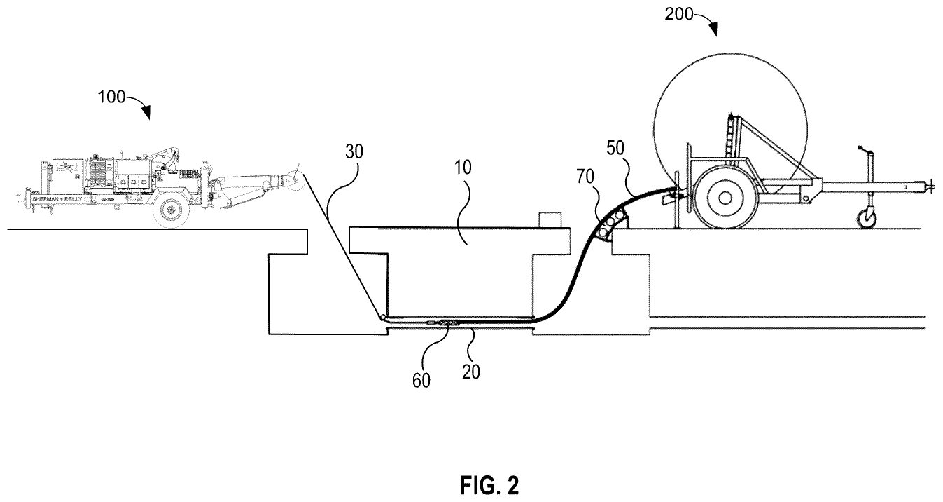

FIGS. 1 and 2 depict an underground stringing apparatus 100 (sometimes referred to herein as “underground stringing equipment”), duct 20, and reel 200, in accordance with the disclosed technology. As shown in FIG. 1, the underground stringing apparatus 100 can be positioned at one end of the duct 20 and the reel 200, which has a conductor 50 disposed on it, can be positioned at the other end of the duct 20. As shown, the duct 20 can extend beneath the ground 10 between various access points. Although the underground stringing apparatus 100 is described herein as being used for installing conductors 50 underground, it will be appreciated that the disclosed technology can be used for installing conductor 50 through ducts 20 whether above ground or underground. Thus, although the disclosed technology is described in the context of an underground stringing apparatus, it will be understood by one of skill in the art that various other applications of the disclosed technology are possible.

The underground stringing apparatus 100, as will be described in greater detail herein, can include features and components that can be used to first blow a cable 30 (or rope) through the duct 20 from the side closest to the underground stringing apparatus 100 to the side closest to the reel 200. The cable 30 can then be attached to a conductor 50 (such as utility lines, fiber optic cables, and the like) and the conductor 50 can be pulled with the cable 30 back through the duct 20 to install the conductor 50 in the duct 20 (as shown in FIG. 2).

To first blow the cable 30 through the duct 20, the underground stringing apparatus 100 can include an air moving device, as will be described in greater detail herein, attached to an air hose 32. Air can be supplied through the air hose 32 to an adapter 34 that can connect the air hose 32 to the duct 20. The adapter 34 can be further configured to permit the cable 30 to pass therethrough. A bird 40 (also sometimes referred to as a torpedo, pig, mouse, etc.) can be attached to a distal end of the cable 30. The bird 40 can have an outer diameter that is slightly less than the inner diameter of the duct 20. Alternatively, the bird 40 can be made from a flexible material and have an outer diameter that is slightly larger than the inner diameter of the duct 20 such that the bird 40 forms a seal with the duct 20. In this way, as air is passed through the air hose 32 and the adapter 34 into the duct 20, a difference in air pressure on opposing sides of the bird 40 will cause the bird 40 to pass through the duct 20, thereby pulling the cable 30 through the duct 20.

Once the cable 30 reaches the other side of the duct 20, the cable 30 can be attached to the conductor 50 using a connector 60 such as a pulling grip or other similar device. The underground stringing apparatus 100 can include a driveline, as will be described in greater detail herein, that can be configured to pull the conductor 50 back through the duct 20. Various sheave blocks 70 or other similar components can be used to help guide the conductor 50 to and from the duct 20 to ensure the conductor 50 does not become damaged. The driveline of the underground stringing apparatus 100 can be sized to pull large conductors 50 long distances, such as several miles depending on the application. For example, the underground stringing apparatus 100 can include a driveline that is capable of pulling with a force of approximately 1,000 lbs, 2,500 lbs, 5,000 lbs, 7,500 lbs, 10,000 lbs or greater to install high voltage conductors 50 over great distances.

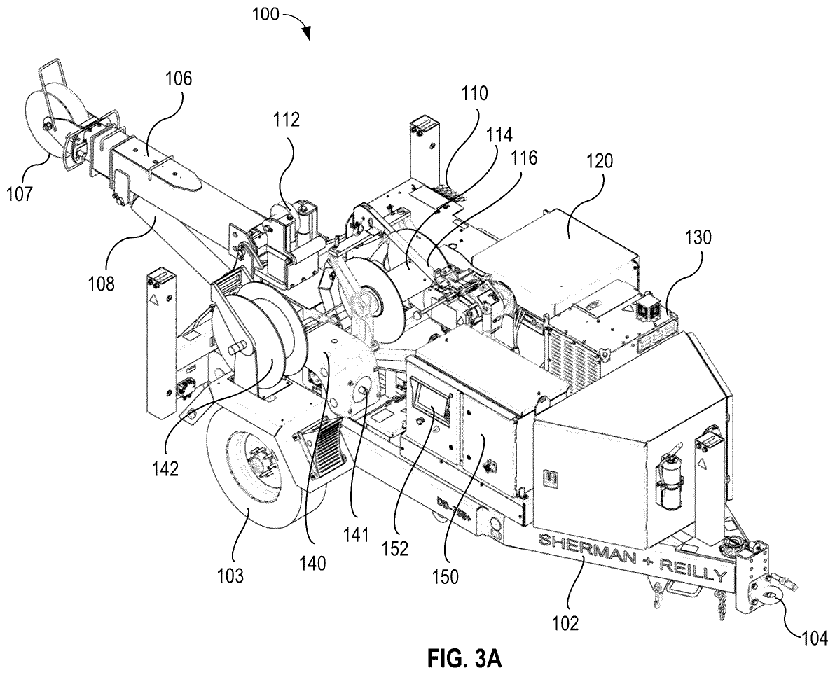

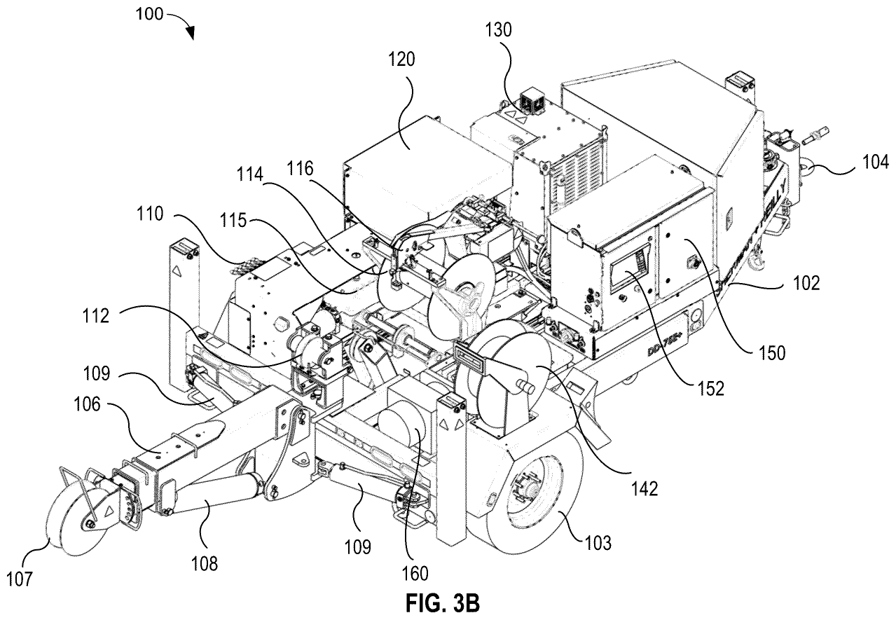

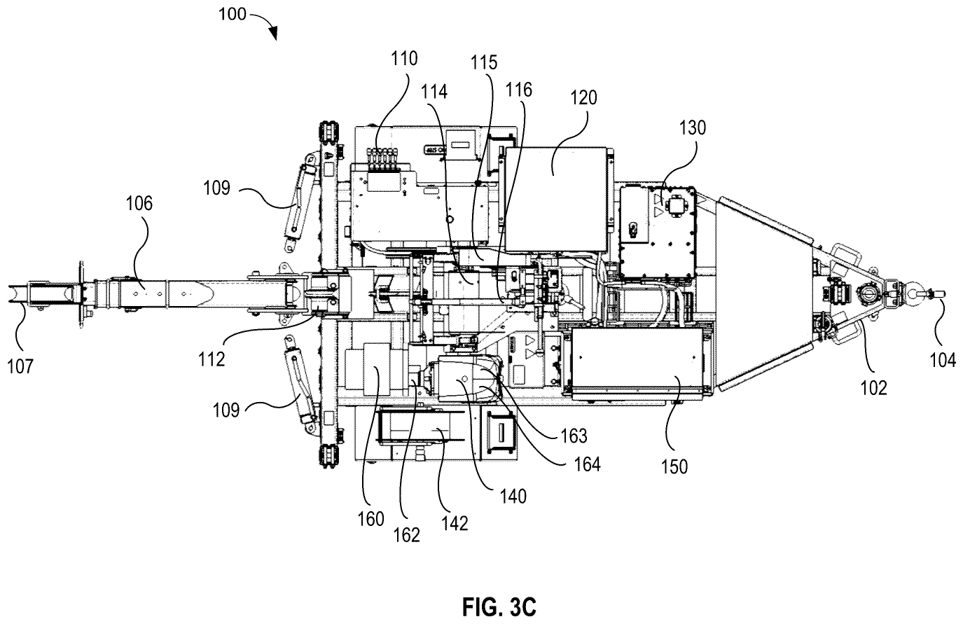

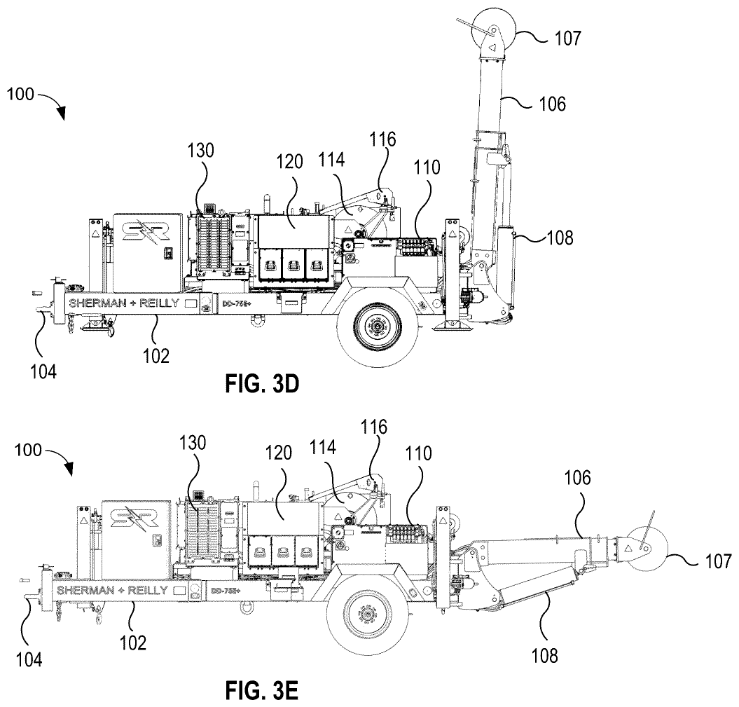

FIG. 3A is a first perspective view of an underground stringing apparatus 100, FIG. 3B is a second perspective view of the underground stringing apparatus 100, FIG. 3C is a top view of the underground stringing apparatus 100, and FIGS. 3D and 3E are side views of the underground stringing apparatus 100, in accordance with the disclosed technology. As shown in FIG. 3A, the underground stringing apparatus 100 can be disposed on a trailer having a chassis 102, wheels 103, and a trailer hitch 104 that can be configured to support the underground stringing apparatus 100. Although shown as being disposed on a trailer, it will be appreciated that the underground stringing apparatus 100 can be disposed on other vehicles or supports such as a truck, van, boat, or support frame. Thus, although shown and described in the context of being disposed on a trailer, it will be appreciated that the disclosure is not so limited.

The underground stringing apparatus 100 can further include a boom 106 that can extend outwardly from the chassis 102 and be configured to articulate or move using one or more actuators. For example, FIG. 3A shows a first actuator 108 that can be configured to move the boom 106 up and down while FIG. 3B shows second actuators 109 that can be configured to move the boom 106 from side to side. The actuators 108, 109 can be hydraulic cylinders, electromechanical actuators, pneumatic actuators, etc. The underground stringing apparatus 100 can further include an actuator control console 110 that can include levers or other control elements to control the actuator 108, 109. The boom 106 can further include a sheave 107 at its distal end that can be configured to rotate and guide the cable 30 (shown in FIGS. 1 and 2) from the underground stringing apparatus 100.

As shown in FIGS. 3D and 3E, the boom 106 can be extended and retracted to increase and decrease the length of the boom 106. Furthermore, the boom 106 can be lifted and lowered between a high position (FIG. 3D) and a low position (FIG. 3E) by the actuator 108. Furthermore, although not shown, the end of the boom 106 can rotate to change an angle of the sheave 107 to ensure the cable 30 is not damaged by rubbing on the sheave 107 or other components of the underground stringing apparatus 100.

The cable 30 can be wound around a driveline 114 that can be configured to rotate in a first direction to pull the cable 30 onto the driveline 114 and in a second direction to deliver the cable 30 from the driveline 114 (payout the cable). The driveline 114 can be configured to rotate via an electric motor 115 (shown in FIG. 3B) that is attached to the driveline 114. As described previously, the electric motor 115 can be sized for pulling the cable 30 and high voltage conductors over several miles depending on the application (e.g., capable of pulling with a force of approximately 1,000 lbs, 2,500 lbs, 5,000 lbs, 7,500 lbs, 10,000 lbs or greater).

The underground stringing apparatus 100 can further include a levelwind 116 that can be configured to align the cable 30 on the driveline 114 (a drum, bull wheel, spool, reel, driveline or the like), to ensure the cable 30 does not become tangled or bound. As will be appreciated, the levelwind 116 can be synced with the driveline 114 to ensure the levelwind 116 moves at the appropriate speed to align the cable 30 onto the driveline 114.

The underground stringing apparatus 100 can include a sheave assembly 112 to help guide the cable 30 from the driveline 114 to the sheave 107 on the boom 106 to ensure the cable 30 does not become damaged from contacting other components of the underground stringing apparatus 100 when being paid out or pulled onto the driveline 114.

The underground stringing apparatus 100 can further include an energy bank 120 that can be configured to provide power to various components of the underground stringing apparatus 100. The energy bank 120 can include a battery, a capacitor, a bank of batteries, and/or a bank of capacitors. The energy bank 120 can be sized to provide sufficient power to the driveline 114 and an air moving device 140.

The underground stringing apparatus 100 can include a generator unit 130 such as a gas generator having an engine that can drive a generator. The generator unit 130 can be configured provide power to the energy bank 120 to charge the energy bank 120 as necessary. For example, if the underground stringing apparatus 100 is used for a conductor installation job that lasts several hours or days, the energy bank 120 may be capable of providing power for the length of the installation job and, therefore, the generator unit 130 can be used to periodically charge the energy bank 120 to ensure sufficient power is available to complete the installation job.

The underground stringing apparatus 100 can include one or more air moving devices 140 that can be configured to provide a supply of air through an air hose 32 (shown in FIG. 1) and to the duct 20 through an adapter 34 as previously described. The air hose 32 can be stored on or otherwise wrapped around a hose reel 142 from which the air hose 32 can be pulled off of or wound onto. The air moving device 140 can be sized and configured to provide a supply of air having a high flow and low pressure as well as a low flow and high pressure. In other words, unlike existing systems which only provide air at a maximum output when turned on, the disclosed technology can be configured to provide a supply of air that is highly tunable to the current conditions and desired installation parameters. In some examples the air moving device 140 can be configured to output an air supply at a pressure ranging from approximately 2 psi to 100 psi and a flow rate of approximately 10 CFM to 1000 CFM. In other examples, the air moving device 140 can be configured to output an air supply at a pressure ranging from approximately 4 psi to 30 psi and approximately between 100 CFM and 220 CFM.

The air moving device 140 can be or include an air compressor and/or an air blower that can be powered by an electric motor 141. Furthermore, although only a single air moving device 140 is shown in FIGS. 3A-3E, it will be appreciated that more than one air moving device 140 can be included in the underground stringing apparatus 100. If the air moving device 140 is a blower, the air moving device 140 can include a roots-type blower, a twin-screw blower, or a centrifugal blower. If the air moving device 140 is a compressor, the air moving device 140 can include a super charger, a rotary screw compressor, a reciprocating air compressor, an axial compressor, a centrifugal compressor, and/or an oilless air compressor. Furthermore, the air moving device 140 can include a combination of two or more different types of air moving devices depending on the particular application and desired performance characteristics.

In some examples, the underground stringing apparatus 100 can include one or more electric motors 141 configured to drive one or more air moving devices 140 in a parallel or a series configuration as controlled by a controller 150 (described further herein). As a non-limiting example, the air moving device 140 can include a first air moving device and a second are moving devices that can operate in parallel when an air supply having a high flow and low pressure is desired and can operate in series when a low flow and high pressure is desired. To illustrate, the first and second air moving devices can operate in parallel during an initial installation phase in which a high flow and low pressure is desired to move the bird 40 through the duct 20 at a relatively fast speed. If the bird 40 encounters an obstruction or is otherwise unable to move forward, the first and second air moving devices can operate in a series configuration to deliver a low flow and high-pressure air supply to drive the bird 40 through the duct 20. In this way, the first and second air moving devices can be utilized together to effectively push the bird 40 and cable 30 through the duct.

Although described as being an electric air moving device 140, the underground stringing apparatus 100 can include one or more combustion engine driven air moving devices (not shown). For example, the underground stringing apparatus 100 can include an electric air moving device 140 as well as a combustion-engine-driven air moving device and the controller 150 can be configured to operate the electric air moving device 140 until the energy bank 120 is depleted at which time the controller 150 can cause the combustion-engine-driven air moving device to operate to continue driving the bird 40. In other examples, the underground stringing apparatus 100 can include multiple combustion-engine-driven air moving devices and be configured to operate the multiple combustion-engine-driven air moving devices in series or parallel as just described, or according to any of the methods described herein. The underground stringing apparatus 100 can further include at least one controller 150 that can be configured to receive data from various sensors and output control signals to various components of the underground stringing apparatus 100.

The controller 150 can be or include one or more digital, analog, or mechanical control elements. The controller 150 can further include a user interface 152 which can display data to, and receive inputs from, an operator of the underground stringing apparatus 100. As will be described in greater detail herein, the controller 150 can be configured to control the underground stringing apparatus 100 to ensure the cable 30 is effectively blown through the duct 20 and that the conductor 50 is effectively pulled back through the duct 20.

As shown in FIGS. 3B and 3C, the underground stringing apparatus 100 can include an air reservoir 160 that can be configured to store a volume of compressed air. As described previously, sometimes when blowing the cable 30 through the duct 20, the bird 40 can encounter an obstruction or otherwise be unable to continue moving through the duct based on the current air supply. The air reservoir 160 can be configured to deliver the volume of compressed air when the bird 40 is unable to continue moving through the duct 20. The air reservoir 160 can be sized to deliver a sufficient volume of the compressed air multiple times to help move the bird 40 through the duct before the air reservoir 160 needs to be refilled with compressed air. A control valve 162 can be in fluid communication with the air reservoir 160 and configured to control an output of air from the air reservoir 160. The control valve 162 can be configured for manual control (e.g., an operator can manually open and close the control valve 162 by actuating a handle or pressing a button) and/or be controlled by the controller 150. For example, the control valve 162 can be an electronically-controlled valve configured to open or close based on an output from the controller 150.

As shown in FIG. 3C, the underground stringing apparatus 100 can further include an air intensifier 163 and/or an air multiplier 164 that can each be in fluid communication with the air moving device 140. The air intensifier 163 can be configured to increase a pressure of the air delivered from the air moving device 140 and to the duct 20 while the air multiplier 164 can be configured to increase a flow of air delivered from the air moving device 140 and to the duct 20. The air intensifier 163 and/or the air multiplier 164 can each be configured to increase the pressure and flow of the air, respectively, whether the air moving device 140 is currently operating in a parallel or series configuration as described herein. Alternatively, the air intensifier 163 can be configured to activate when the air moving device 140 is operating in series to help further increase the pressure while the air multiplier 164 can be configured to activate when the air moving device 140 is operating in parallel to help further increase the flowrate.

The air intensifier 163, for example, can be an air-driven, air pressure booster configured to increase the pressure of the air delivered to the duct 20. If the air intensifier 163 is an air-drive, air pressure booster, at least a portion of the air used to drive the air-driven, air pressure booster can be received from the air moving device 140. Alternatively, or in addition, the air intensifier 163 can be an electrically-driven or a gas-powered air intensifier configured to increase the pressure of the air delivered to the duct 20.

The air multiplier 164 can be an active or a passive system configured to increase the flow of the air delivered to the duct 20. The air multiplier 164, for example, can be configured to increase the air flow using the Coanda effect. Alternatively, or in addition, the air multiplier 164 can be a device configured to deliver additional air flow (e.g., an additional air compressor, supercharger, air reservoir, etc.) By delivering a greater volume of air to the duct 20, the underground stringing apparatus 100 can be configured to provide a greater moving force to the bird 40 to cause the bird 40 to move through the duct 20.

The air intensifier 163 and the air multiplier 164 can each be configured to turn on and off. In other words, the underground stringing apparatus 100 can activate the air intensifier 163 and/or the air multiplier 164 when a greater pressure or volume of air is needed to cause the bird 40 to move. For example, the air intensifier 163 and the air multiplier 164 can each be connected to the air moving device 140 via pipes and valves and air can be routed through the air intensifier 163 and/or the air multiplier 164 as desired. Or the air intensifier 163 and/or the air multiplier 164 can have one or more actuatable components to cause the air intensifier 163 and/or the air multiplier 164 to turn on and off as desired.

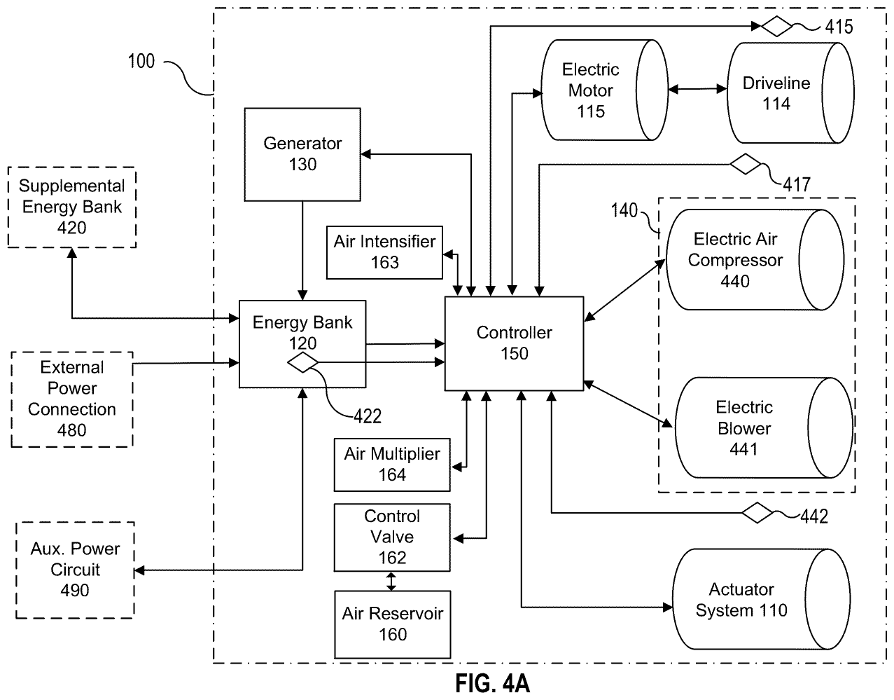

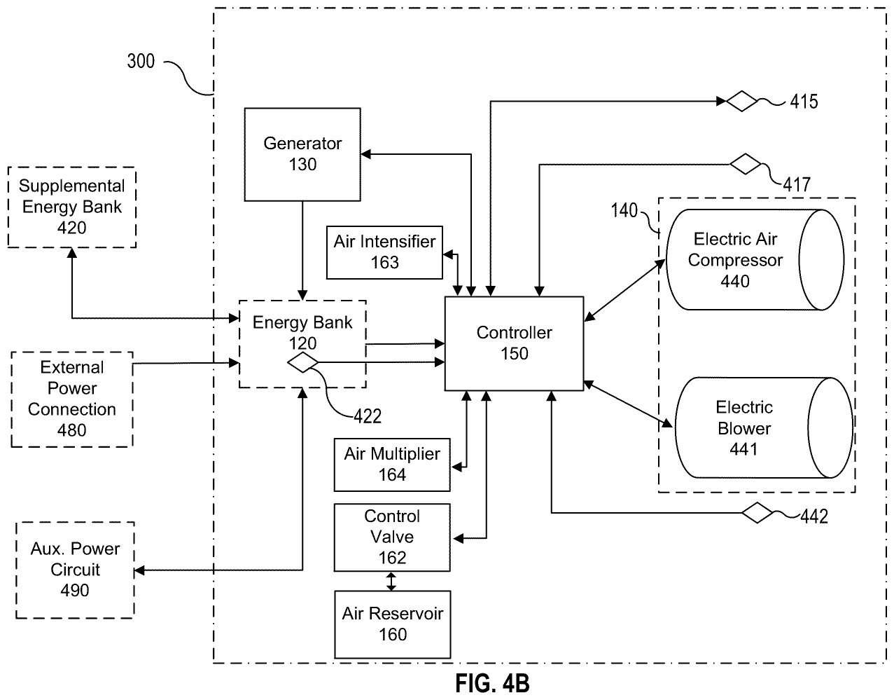

FIG. 4A is a block diagram of an example control system of an underground stringing apparatus 100, in accordance with the disclosed technology. As shown in FIG. 4A, the controller 150 can be in communication with various components of the underground stringing apparatus 100. The controller 150 can receive power from the energy bank 120. The controller 150 can further be configured to receive data from a temperature sensor 422 that is configured to detect a temperature of the energy bank 120. If the energy bank 120 has begun to overheat, the controller 150 can output a warning to notify the operator that the energy bank 120 is overheating. The controller 150 can further be configured to determine if a temperature of the energy bank 120 is greater than a high temperature threshold and be configured to shut the underground stringing apparatus 100 to prevent the energy bank 120 from overheating and becoming damaged.

The controller 150 can also be configured to reduce an output of the underground stringing apparatus 100 if the temperature of the energy bank 120 is below a low-temperature threshold. For example, if the temperature of the energy bank 120 is less than the low-temperature threshold, it can be indicative of the energy bank 120 being unable to output power at a full output capacity. For example, if the energy bank 120 is at a temperature less than the low-temperature threshold, the energy bank 120 may be damaged if too great of a load is placed on it. In this instance, the controller 150 can reduce the output of the air moving device 140 and/or the driveline 114 to ensure the load on the energy bank 120 remains below the load wherein the energy bank 120 may be damaged.

As the temperature of the energy bank 120 rises, the controller 150 can determine that the temperature of the energy bank 120 is greater than or equal to the low-temperature threshold and permit the underground stringing apparatus 100 to perform the blower or pulling operation at the full capacity of the energy bank 120.

The controller 150 can be further configured to determine a charge level of the energy bank 120 and determine if the charge level is less than or equal to a low charge threshold. If a charge level of the energy bank 120 is less than or equal to the low charge threshold, the controller 150 can be configured to output a control signal to cause the generator unit 130 to activate. By activating the generator unit 130, the generator unit 130 can begin to provide power to the energy bank 120 to recharge the energy bank 120.

As shown in FIG. 4A, the energy bank 120 can be further configured to connect to a supplemental energy bank 420 that can provide additional charge to the energy bank 120. For example, the supplemental energy bank 420 can be an external battery or bank of batteries disposed on a trailer that can be transported to worksite to serve as a backup or supplemental supply of power to the energy bank 120. The energy bank 120 can be further configured to receive power from an external power connection 480. The external power connection 480 can be a connection to the utility grid to receive grid power for charging the energy bank 120.

Further still, the energy bank 120 can be further configured to provide power to an auxiliary power circuit 490 that can be configured to provide power to various auxiliary units. The auxiliary power circuit 490 can include, for example and not limitation, a 120-volt, a 48-volt, or a 12-volt circuit that is configured to provide power to various electrical equipment such as power tools, lights, computers, etc. In this way, the energy bank 120 can be used for providing power to tools or devices that are necessary for completing the underground stringing operation. Similarly, the 48-volt and 12-volt circuits can be configured to provide a charge to other connected batteries or energy banks of equipment used with the underground stringing apparatus 100. As will be appreciated, this can be particularly helpful in locations where grid power or other power sources are unavailable.

The controller 150 can be further configured to control the operation of the electric motor 115 and, subsequently, the driveline 114. For example, the controller 150 can be configured to control a speed of the cable 30 being paid out, or pulled onto, the driveline 114. For instance, if the cable 30 is being blown through the duct 20, the controller 150 can be configured to receive speed data from a speed sensor 415 configured to detect a speed of the driveline 114 and/or the cable 30. For example, the speed sensor 415 can be disposed near the driveline 114 and configured to detect a speed at which the driveline 114 is rotating for the controller 150 to interpolate the speed of the bird 40 and cable 30 traveling through the duct. Alternatively, or in addition, the controller 150 can be configured to determine a speed or approximate speed of the bird 40 traveling through the duct 20 based on a detected speed of the cable 30. In either case, the controller 150 can be configured to determine if the cable 30 is traveling at or below a low-speed threshold. If the cable 30 is traveling at or below the low-speed threshold, the controller 150 can be configured to increase a supply of air to the duct. For example, the controller 150 can be configured to increase an output of the air from the air moving device 140, open the control valve 162 to release pressurized air from the air reservoir 160, activate the air intensifier 163, and/or activate the air multiplier 164. By supplying an increased air supply or a high-pressure air supply, the bird 40 can be pushed through the duct 20 at a greater speed or be dislodged from a stuck position.

The controller 150 can be further configured to control the speed of the driveline 114 by controlling the output of the electric motor 115. For example, the controller 150 can cause the driveline 114 to rotate via the electric motor 115 at a predetermined speed and can increase or decrease the speed of the driveline 114 to ensure the cable 30 does not become tangled or does not experience too great of a force from the bird 40 being pushed too quickly by the air moving device 140. Further, the controller 150 can be configured to control a speed of the driveline 114 when the cable 30 is being pulled onto the driveline 114 when pulling the conductor 50 back through the duct.

The controller 150 can also be configured to control both the air moving device 140 and the driveline 114 to ensure the speed at which the cable 30 is paid out from the driveline 114 and the supply of air are synced to ensure the maximum efficiency is achieved when completing the blowing operation. For example, if the air moving device 140 is operating at a maximum air output but the driveline 114 is rotating at a speed slower than the cable 30 would normally be able to be paid out under the maximum air output conditions, there will be much wasted energy by operating the air moving device at the maximum air output. Therefore, to help conserve energy and ensure the life of the energy bank 120 is maximized, the controller 150 can be configured to operate the driveline 114 to pay out cable at a speed that corresponds to the speed at which the cable 30 could move under the current air supply conditions. For example, as air supply is increased the cable 30 can likely move more quickly through the duct 20 and the controller 150 will increase the speed at which the driveline 114 rotates to ensure the cable 30 is paid out at a speed corresponding to the speed at which the cable 30 is being moved by the air moving device 140.

Another way of ensuring the energy from the energy bank 120 is being used efficiently is by detecting a tension of the cable 30 using a tension sensor 417. The tension sensor 417, for example, can be incorporated into the electric motor 115, the driveline 114, and/or be a separate sensor configured to detect a tension on the cable 30. The controller 150 can receive tension data from the tension sensor 417 and determine whether a tension of the cable 30 is greater than or equal to a maximum tension threshold. If the tension of the cable 30 is greater than or equal to the maximum tension threshold, this is likely an indication that the driveline 114 is not paying out cable 30 quickly enough to keep up with the bird 40 moving through the duct 20. In which case, the controller 150 can determine that the speed of the driveline 114 should be increased and/or the output of the air moving device 140 should be decreased to maintain a tension on the cable 30 that is less than the maximum tension threshold, thereby efficiently utilizing energy from the energy bank 120 to complete the blowing operation.

As shown in FIG. 4A, the air moving device 140 can be or include an electric air compressor 440 and/or an electric blower 441 that can each be controlled by the controller 150. As described previously, if the air moving device 140 is an electric air compressor 440, the electric air compressor 440 can be a super charger, a rotary screw compressor, a reciprocating air compressor, an axial compressor, or a centrifugal compressor. Alternatively, if the air moving device 140 is an electric blower 441, the electric blower 441 can be a roots-type blower, a twin-screw blower, or a centrifugal blower. In some examples, the air moving device 140 can be two or more electric air compressors 440 configured to be operated in series and parallel configurations. Similarly, the air moving device can be two or more electric blowers 441 configured to be operated in series and in parallel configurations. If more than one electric air compressor 440 is used and/or more than one electric blower 441 is used, a first compressor 440 (or first blower 441) can be configured to output air at a first pressure and flowrate and a second compressor (or second blower 441) can be configured to output air at a second pressure and flowrate different from the first pressure and flowrate. Furthermore, one or more combinations of the above-listed compressors and blowers can be used. No matter the configuration, the controller 150 can be configured to output a control signal to control the operation of the air moving device 140 to output the appropriate supply of air under the give circumstances.

To illustrate, if the air moving device 140 comprises an electric air compressor 440 and an electric blower 441, the controller 150 can initially control just the electric blower 441 to output a first flow of air to drive the cable 30 through the duct 20. If the controller 150 determines that the speed of the cable 30 is less than or equal to the low-speed threshold, the controller 150 can continue to increase the speed of the electric air blower 441 until the speed of the cable 30 is greater than the low-speed threshold. If, after reaching the maximum output of the electric air blower 441, the cable 30 still is not traveling at a speed greater than the low-speed threshold, the controller 150 can activate the electric air compressor 440 to provide additional supply of air to the duct 20. The controller 150 can continue to increase the output of the electric air compressor 440 to provide a supply of air having a greater pressure to cause the cable 30 to resume travel at a speed greater than or equal to the low-speed threshold.

Continuing with the example above, if the controller 150 increases the output of the electric blower 441 and the electric air compressor 440 to the maximum output of both air moving devices and the cable 30 is still not traveling at a speed greater than the low-speed threshold, the controller 150 can activate the control valve 162 to release a supply of high-pressure air from the air reservoir 160, activate the air intensifier 163, and/or activate the air multiplier 164 to deliver a greater supply of air to cause the speed of the cable 30 to increase. In this way, the controller 150 can be configured to operate as efficiently as possible to conserve battery power but also to ensure the cable 30 is pushed through the duct 20 at a speed greater than the low-speed threshold. The low-speed threshold, for example, can be a speed below which it is likely that the bird 40 has become stuck, is encountering greater drag, or the weight of the cable 30 is causing the cable 30 to move more slowly through the duct 20.

The controller 150 can be further configured to determine if the cable 30 has remained stationary for a predetermined length of time. If the cable 30 remains stationary for a predetermined length of time, it is likely that the bird 40 has become stuck or the weight of the cable 30 is too great for the bird 40 to move the cable 30 with the current supply of air. If the cable 30 has remained stationary for the predetermined length of time, the controller 150 can be configured to increase the output of the air moving device 140, activate the air intensifier 163, activate the air multiplier 164, and/or activate the control valve 162 to cause the bird 40 and cable 30 to continue moving through the duct.

The controller 150 can also be in communication with a pressure sensor 442 that can be configured to detect a pressure of the air in the duct 20. The controller 150 can be configured to control an output of the air moving device 140 to ensure the pressure in the duct 20 does not exceed a maximum pressure of the duct 20. As will be appreciated, if the air pressure in the duct reaches too high a pressure, the duct 20 can rupture or otherwise become damaged. Thus, by monitoring the air pressure in the duct 20 and then controlling the air moving device 140 to maintain the pressure below a maximum pressure threshold, the controller 150 can ensure the duct 20 does not become damaged.

The controller 150 can be further configured to determine if the pressure in the duct 20 is less than a predetermine pressure. The predetermined pressure can be indicative of a minimum pressure required to cause the bird 40 to move through the duct 20. If the detected pressure is less than the predetermined pressure, the controller 150 can output a control signal to increase the output of the electric air moving device 140, activate the air intensifier 163, activate the air multiplier 164, and/or actuate the control valve 162 to increase the flow of air through the duct 20.

As shown in FIG. 4A, the controller 150 can be further in communication with an actuator system 110 that can be configured to control the first actuator 108 and the second actuator 109 to move the boom 106 up, down, and/or side to side as necessary. As will be appreciated, the actuator system 110 can be configured to control the flow of hydraulic fluid to cause movement of the boom 106.

Although the components shown and described in FIG. 4A are described as being part of the stringing apparatus 100, it will be appreciated that the many of the components can be incorporated into a stand-alone unit 300 such as that shown in FIG. 4B. In other words, the disclosed technology includes a stand-alone unit 300 that can include all of the same components as the stringing apparatus 100 without the driveline 114, electric motor 115 to drive the driveline 114, and the actuator system. In other words, the air moving device 140 and associated components (controller 150, pressure sensor 442, generator 130, air intensifier 163, energy bank 120, temperature sensor 422, air multiplier 164, control valve 162, and air reservoir 160 can each be mounted on a stand-alone unit 300 that can be portable (e.g., on a cart, trailer, container, etc.) and used in conjunction with a stringing apparatus 100 or for other applications. In this way, the features and methods described herein can be incorporated into a smaller system than the entire stringing apparatus 100. In some examples, the stand-alone unit 300 does not include the energy bank 120 and the stand-alone unit 300 can be configured to draw energy from an energy bank that is separate from the stand-alone unit 300 (e.g., an energy bank on the stringing apparatus 100 or a separate energy bank).

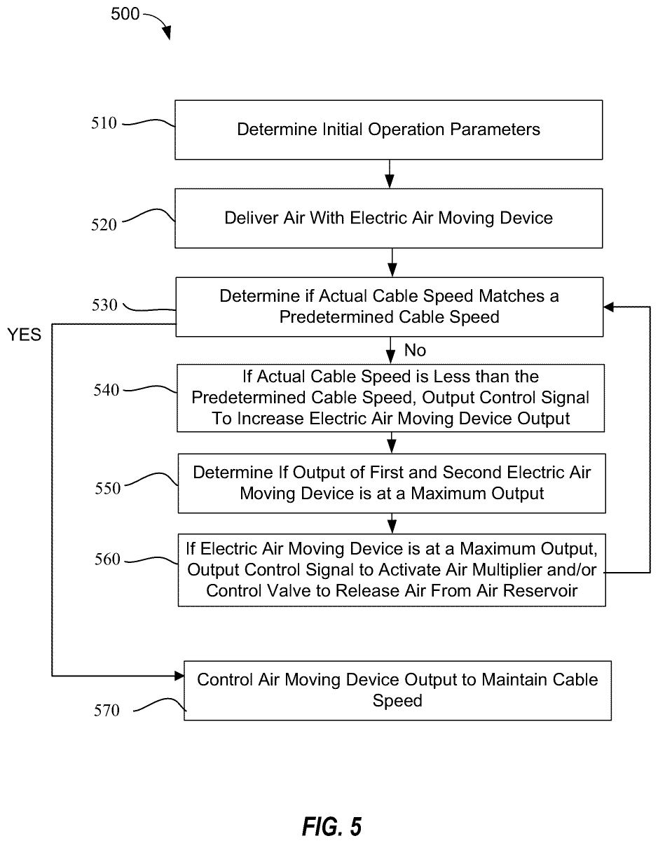

FIG. 5 is a flowchart of an example method 500 of installing an underground cable, in accordance with the disclosed technology. The method 500 can include determining 510 initial operation parameters. Determining 510 initial operation parameters can include determining at what speed the cable 30 should be installed, what pressure the maximum output of the air moving device 140 should be, the length of cable 30 to be paid out through the duct 20, the tension at which the conductor 50 can be pulled through the duct, etc. The method 500 can further include delivering 520 air with an electric air moving device (e.g., the electric air moving device 140).

The method 500 can further include determining 530 if the actual speed of the cable 30 is less than the predetermined cable speed (i.e., the low-speed threshold). If the actual speed of the cable 30 is less than the predetermine cable speed, the method 500 can further include outputting 540 a control signal to increase the output from the electric air moving device 140. Outputting 540 a control signal to increase the output from the electric air moving device 140 can include increasing the speed of the electric air moving device 140 and/or, if the underground stringing apparatus 100 includes a second air moving device 140, outputting 540 a control signal to increase the output from the electric air moving device 140 can include activating the second electric air moving device 140.

The method 500 can further include determining 550 if the output of the electric air moving device 140 is at a maximum output. If the output of the electric air moving device 140 is at a maximum output, the method 500 can include outputting 560 a control signal to activate the air multiplier 164 and/or open the control valve 162 to release pressurized air from the air reservoir 160.

The method 500 can once again include determining 530 if the actual cable speed is matches a predetermined cable speed and, if not, repeating the above-describe processes. If the actual cable speed matches the predetermined cable speed, the method 500 can include controlling 570 the air moving device 140 output to maintain the cable speed.

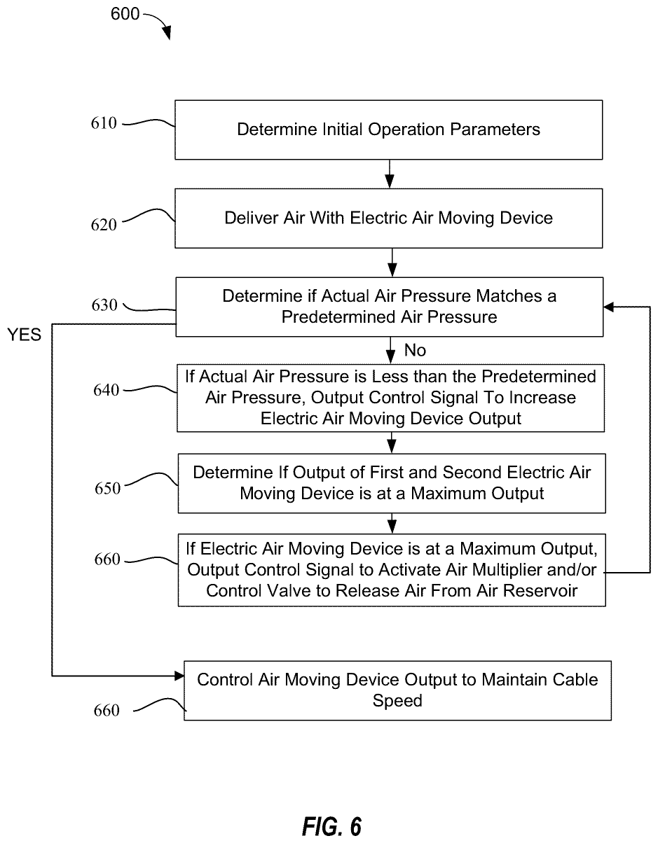

FIG. 6 is a flowchart of an example method 600 of installing an underground cable, in accordance with the disclosed technology. The method 600 can include determining 610 initial operation parameters. Determining 610 initial operation parameters can include determining at what speed the cable 30 should be installed, what pressure the maximum output of the air moving device 140 should be, the length of cable 30 to be paid out through the duct 20, the tension at which the conductor 60 can be pulled through the duct, etc. The method 600 can further include delivering 620 air with an electric air moving device (e.g., the electric air moving device 140).

The method 600 can further include determining 630 if the actual air pressure in the duct 20 is less than the predetermined air pressure (i.e., a low air pressure threshold). If the air pressure in the duct is less than the predetermined air pressure, the method 600 can further include outputting 640 a control signal to increase the output from the electric air moving device 140. Outputting 640 a control signal to increase the output from the electric air moving device 140 can include increasing the speed of the electric air moving device 140 and/or, if the underground stringing apparatus 100 includes a second air moving device 140, outputting 640 a control signal to increase the output from the electric air moving device 140 can include activating the second electric air moving device 140.

The method 600 can further include determining 650 if the output of the electric air moving device 140 is at a maximum output. If the output of the electric air moving device 140 is at a maximum output, the method 600 can include outputting 660 a control signal to activate the air multiplier 164 and/or open the control valve 162 to release pressurized air from the air reservoir 160.

The method 600 can once again include determining 630 if the actual air pressure matches a predetermined cable speed and, if not, repeating the above-describe processes. If the actual air pressure matches the predetermined air pressure, the method 600 can include controlling 670 the air moving device 140 output to maintain the cable speed.

As will be appreciated, the methods 500 and 600 just described is offered for illustrative purposes. The methods 500 and 600 can include more or fewer features than those just described. Furthermore, although described in a particular order, one of skill in the art will appreciate that the methods 500 and 600 do not necessarily need to be implemented in the order presented herein. Therefore, the methods 500 and 600 should be construed as one example of operating the underground stringing apparatus 100 and other method of operating the underground stringing apparatus 100 according to the various other examples described herein can also be implemented.

The disclosed technology described herein can be further understood according to the following clauses:

Clause 1: An air moving system for a stringing apparatus, the air moving system comprising: an energy bank; an electric air moving device in electrical communication with the energy bank and configured to output a supply of air to cause a cable to move along a duct; and at least one controller configured to: determine a speed of the cable moving along the duct; and control the output of the supply of air of the electric air moving device to control the speed of the cable based at least in part on the determined speed of the cable.

Clause 2: The air moving system of Clause 1, wherein the electric air moving device comprises an air blower.

Clause 3: The air moving system of Clause 2, wherein the air blower is at least one of a roots-type blower, a twin-screw blower, or a centrifugal blower.

Clause 4: The air moving system of Clause 1, wherein the electric air moving device comprises an air compressor.

Clause 5: The air moving system of Clause 4, wherein the air compressor is at least one of a super charger, a rotary screw compressor, a reciprocating air compressor, an axial compressor, or a centrifugal compressor.

Clause 6: The air moving system of any of the preceding Clauses, wherein the air moving device is a first electric air moving device, the air moving system further comprising a second electric air moving device.

Clause 7: The air moving system of Clause 6, wherein the at least one controller is further configured to: determine whether the determined speed of the cable is less than a predetermined line speed; and in response to determining that the speed of the cable is less than the predetermined line speed, control the output of the supply of air of the first electric air moving device and the second electric air moving device to increase the speed of the cable.

Clause 8: The air moving system of Clause 7, wherein the at least one controller is further configured to: output instructions to operate the first electric air moving device and the second electric air moving device in at least a first mode and a second mode, wherein the first mode comprises operating the first electric air moving device and the second electric air moving device in a parallel configuration, and wherein the second mode comprises operating the first electric air moving device and the second electric air moving device in a series configuration.

Clause 9: The air moving system of Clause 8, wherein operating the first electric air moving device and the second electric air moving device in the parallel configuration provides a first air supply having a high flow rate and a low pressure, and wherein operating the first electric air moving device and the second electric air moving device in the series configuration provides a second electric air supply having a low flow rate and a high pressure.

Clause 10: The air moving system of any of the preceding Clauses further comprising an air multiplier, the air multiplier configured to increase a flow rate of air delivered by the electric air moving device.

Clause 11: The air moving system of Clause 10, wherein the at least one controller is further configured to: determine whether the speed of the cable is less than a predetermined line speed; and in response to determining that the speed of the cable is less than the predetermined line speed, output a control signal to the air multiplier to activate the air multiplier and increase the flow rate of air.

Clause 12: The air moving system of any of the preceding Clauses further comprising an air reservoir, the air reservoir configured to store a volume of compressed air.

Clause 13: The air moving system of Clause 12, wherein the at least one controller is further configured to: determine whether the speed of the cable is less than a predetermine line speed; and in response to determining that the speed of the cable is less than the predetermine line speed, output a control signal to open a control valve to release at least a portion of the volume of compressed air from the air reservoir.

Clause 14: The air moving system of Clause 13, wherein the control valve is configured to be manually opened or closed.

Clause 15: The air moving system of any of the preceding Clauses, wherein the at least one controller is further configured to: determine whether the cable has remained stationary for a predetermined length of time, and in response to determining that the cable has remained stationary for the predetermined length of time, output a control signal to increase the output of the supply of air of the electric air moving device.

Clause 16: The air moving system of Clause 15, wherein the at least one controller is further configured to: in response to determining that the cable has remained stationary for the predetermined length of time, output a control signal to activate the air multiplier.

Clause 17: The air moving system of Clause 16, wherein the at least one controller is further configured to: in response to determining that the cable has remained stationary for the predetermined length of time, output a control signal to open a control valve to release at least a portion of a volume of compressed air from an air reservoir.

Clause 18: The air moving system of any of the preceding Clauses, wherein the at least one controller is further configured to: receive a pressure value from a pressure sensor, the pressure value indicative of a pressure in a duct; and in response to determining that the pressure value is less than a minimum pressure value, output a control signal to increase the output of the supply of air of the electric air moving device.

Clause 19: The air moving system of any of the preceding Clauses, wherein the at least one controller is further configured to: receive a pressure value from a pressure sensor, the pressure value indicative of a pressure in a duct; and in response to determining that the pressure value is greater than a maximum pressure value, output a control signal to decrease the output of the supply of air of the electric air moving device.

Clause 20: A stringing apparatus comprising: an energy bank; a driveline in electrical communication with the energy bank and configured to receive or to deliver a cable; an electric air moving device in electrical communication with the energy bank and configured to output a supply of air; and at least one controller configured to: determine a speed of a cable being delivered from the driveline; and control the output of the supply of air of the electric air moving device to control the speed of the cable based at least in part on the determined speed of the cable.

Clause 21: The stringing apparatus of Clause 20, wherein the electric air moving device comprises an air blower.

Clause 22: The stringing apparatus of Clause 20, wherein the electric air moving device comprises an air compressor.

Clause 23: The stringing apparatus of any of Clauses 20-22, wherein the electric air moving device is configured to output (1) a first air supply having a high flow rate and low pressure, and (2) a second air supply having a low flow rate and high pressure.

Clause 24: The stringing apparatus of any of Clauses 20-23, wherein the air moving device is a first electric air moving device, the stringing apparatus further comprising a second electric air moving device.

Clause 25: The stringing apparatus of Clause 24, wherein the at least one controller is further configured to: determine whether the determined speed of the cable is less than a predetermined line speed; and in response to determining that the speed of the cable is less than the predetermined line speed, control the output of the supply of air of the first electric air moving device and the second electric air moving device to increase the speed of the cable.

Clause 26: The stringing apparatus of Clause 25, wherein the at least one controller is further configured to: output instructions to operate the first electric air moving device and the second electric air moving device in at least a first mode and a second mode, wherein the first mode comprises operating the first electric air moving device and the second electric air moving device in a parallel configuration, and wherein the second mode comprises operating the first electric air moving device and the second electric air moving device in a series configuration.

Clause 27: The stringing apparatus of Clause 26, wherein operating the first electric air moving device and the second electric air moving device in the parallel configuration provides a first air supply having a high flow rate and a low pressure, and wherein operating the first electric air moving device and the second electric air moving device in the series configuration provides a second air supply having a low flow rate and a high pressure.

Clause 28: The stringing apparatus of any of Clauses 20-27 further comprising an air multiplier, the air multiplier configured to increase a flow rate of air delivered by the electric air moving device.

Clause 29: The stringing apparatus of Clause 28, wherein the at least one controller is further configured to: determine whether the speed of the cable is less than a predetermined line speed; and in response to determining that the speed of the cable is less than the predetermined line speed, output a control signal to the air multiplier to activate the air multiplier and increase the flow rate of air.

Clause 30: The stringing apparatus of any of Clauses 20-29 further comprising an air reservoir, the air reservoir configured to store a volume of compressed air.

Clause 31: The stringing apparatus of Clause 30, wherein the at least one controller is further configured to: determine whether the speed of the cable is less than a predetermine line speed; and in response to determining that the speed of the cable is less than the predetermine line speed, output a control signal to open a control valve to release at least a portion of the volume of compressed air from the air reservoir.

Clause 32: The stringing apparatus of Clause 31, wherein the control valve is configured to be manually opened or closed.

Clause 33: The stringing apparatus of any of any of Clauses 20-32, wherein the at least one controller is further configured to: determine whether the cable has remained stationary for a predetermined length of time, and in response to determining that the cable has remained stationary for the predetermined length of time, output a control signal to increase the output of the supply of air of the electric air moving device.

Clause 34: The stringing apparatus of Clause 33, wherein the at least one controller is further configured to: in response to determining that the cable has remained stationary for the predetermined length of time, output a control signal to activate the air multiplier.

Clause 35: The stringing apparatus of Clause 34, wherein the at least one controller is further configured to: in response to determining that the cable has remained stationary for the predetermined length of time, output a control signal to open a control valve to release at least a portion of the volume of compressed air from the air reservoir.

Clause 36: The stringing apparatus of any of Clauses 20-35 further comprising a generator configured to charge the energy bank.

Clause 37: The stringing apparatus of Clause 36, wherein the at least one controller is further configured to: determine a charge level of the energy bank; and in response to determining that the energy bank charge level is less than a threshold charge level, output a control signal to activate the generator to begin charging the energy bank.

Clause 38: The stringing apparatus of any of Clauses 20-37, wherein the energy bank further comprises a temperature sensor configured to detect a temperature of the energy bank.

Clause 39: The stringing apparatus of Clause 38, wherein the at least one controller is further configured to: determine a temperature of the energy bank; and in response to determining that the energy bank temperature is greater than a threshold temperature, output a control signal to reduce the output of the supply of air of the electric air moving device.

Clause 40: The stringing apparatus of Clauses 38 or 39, wherein the at least one controller is further configured to: determine a temperature of the energy bank; and in response to determining that the energy bank temperature is greater than a threshold temperature, output a control signal to reduce an output of the driveline.

Clause 41: The stringing apparatus of any of Clauses 20-40, wherein the at least one controller is further configured to: receive a pressure value from a pressure sensor, the pressure value indicative of a pressure in a duct; and in response to determining that the pressure value is less than a minimum pressure value, output a control signal to increase the output of the supply of air of the electric air moving device.

Clause 42: The stringing apparatus of any of Clauses 20-41, wherein the at least one controller is further configured to: receive a pressure value from a pressure sensor, the pressure value indicative of a pressure in a duct; and in response to determining that the pressure value is greater than a maximum pressure value, output a control signal to decrease the output of the supply of air of the electric air moving device.

Clause 43: The stringing apparatus of any of Clauses 20-42, wherein the at least one controller is further configured to: determine a charge level of the energy bank; and control the output of the supply of air of the electric air moving device to extend a life of the energy bank based on the charge level.

Clause 44: The stringing apparatus of any of Clauses 20-43, wherein the at least one controller is further configured to: determine a charge level of the energy bank; and control an output of the driveline to extend a life of the energy bank based on the charge level.

Clause 45: The stringing apparatus of any of Clauses 20-44, wherein the stringing apparatus is configured to deliver a cable through an underground duct.

Clause 46: The stringing apparatus of any of Clauses 20-45 further comprising a boom configured to extend and rotate to align the cable with a duct.

Clause 47: The stringing apparatus of any of Clauses 20-46, wherein the electric air moving device comprises an oilless air compressor.

Clause 48: The stringing apparatus of any of Clauses 20-47 further comprising an expandable air hose in fluid communication with the electric air moving device.

Clause 49: An air moving system for a stringing apparatus, the air moving system comprising: an air moving device configured to output a supply of air to cause a cable to move along a duct; and at least one controller configured to: determine a speed of the cable moving along the duct; and control the output of the supply of air of the air moving device to control the speed of the cable based at least in part on the determined speed of the cable.

Clause 50: The air moving system of claim 48, wherein the air moving device is electrically-driven.

Clause 51: The air moving system of claim 48, wherein the air moving device is driven by a combustion engine.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An air moving system for a stringing apparatus, the air moving system comprising:
an energy bank;
an electric air moving device in electrical communication with the energy bank and configured to output a supply of air to cause a cable to move along a duct; and
at least one controller configured to:
determine a speed of the cable moving along the duct; and
control the output of the supply of air of the electric air moving device to control the speed of the cable based at least in part on the determined speed of the cable.

2. The air moving system of claim 1, wherein the electric air moving device is at least one of a roots-type blower, a twin-screw blower, a centrifugal blower, a super charger, a rotary screw compressor, a reciprocating air compressor, an axial compressor, or a centrifugal compressor.

3. The air moving system of claim 1, wherein the air moving device is a first electric air moving device, the air moving system further comprising a second electric air moving device.

4. The air moving system of claim 3, wherein the at least one controller is further configured to:
determine whether the determined speed of the cable is less than a predetermined line speed; and
in response to determining that the speed of the cable is less than the predetermined line speed, control the output of the supply of air of the first electric air moving device and the second electric air moving device to increase the speed of the cable.

5. The air moving system of claim 4, wherein the at least one controller is further configured to:
output instructions to operate the first electric air moving device and the second electric air moving device in at least a first mode and a second mode,
wherein the first mode comprises operating the first electric air moving device and the second electric air moving device in a parallel configuration, and
wherein the second mode comprises operating the first electric air moving device and the second electric air moving device in a series configuration.

6. The air moving system of claim 5, wherein operating the first electric air moving device and the second electric air moving device in the parallel configuration provides a first air supply having a high flow rate and a low pressure, and
wherein operating the first electric air moving device and the second electric air moving device in the series configuration provides a second electric air supply having a low flow rate and a high pressure.

7. The air moving system of claim 1 further comprising an air multiplier, the air multiplier configured to increase a flow rate of air delivered by the electric air moving device.

8. The air moving system of claim 7, wherein the at least one controller is further configured to:
determine whether the speed of the cable is less than a predetermined line speed; and
in response to determining that the speed of the cable is less than the predetermined line speed, output a control signal to the air multiplier to activate the air multiplier and increase the flow rate of air.

9. The air moving system of claim 1 further comprising an air reservoir, the air reservoir configured to store a volume of compressed air.

10. The air moving system of claim 9, wherein the at least one controller is further configured to:
determine whether the speed of the cable is less than a predetermine line speed; and
in response to determining that the speed of the cable is less than the predetermine line speed, output a control signal to open a control valve to release at least a portion of the volume of compressed air from the air reservoir.

11. The air moving system of claim 10, wherein the control valve is configured to be manually opened or closed.

12. The air moving system of claim 1, further comprising an air multiplier, the air multiplier configured to increase a flow rate of air delivered by the electric air moving device, wherein the at least one controller is further configured to:
determine whether the cable has remained stationary for a predetermined length of time, and
in response to determining that the cable has remained stationary for the predetermined length of time, output a control signal to increase the output of the supply of air of the electric air moving device.

13. The air moving system of claim 12, wherein the at least one controller is further configured to:
in response to determining that the cable has remained stationary for the predetermined length of time, output a control signal to activate the air multiplier.

14. The air moving system of claim 13, wherein the at least one controller is further configured to:
in response to determining that the cable has remained stationary for the predetermined length of time, output a control signal to open a control valve to release at least a portion of a volume of compressed air from an air reservoir.

15. The air moving system of claim 14, wherein the at least one controller is further configured to:
receive a pressure value from a pressure sensor, the pressure value indicative of a pressure in a duct; and
in response to determining that the pressure value is less than a minimum pressure value, output a control signal to increase the output of the supply of air of the electric air moving device.

16. The air moving system of claim 1, wherein the at least one controller is further configured to:
receive a pressure value from a pressure sensor, the pressure value indicative of a pressure in a duct; and
in response to determining that the pressure value is greater than a maximum pressure value, output a control signal to decrease the output of the supply of air of the electric air moving device.

17. A stringing apparatus comprising:
an energy bank;
a driveline in electrical communication with the energy bank and configured to receive or to deliver a cable;
an electric air moving device in electrical communication with the energy bank and configured to output a supply of air; and
at least one controller configured to:
determine a speed of a cable being delivered from the driveline; and
control the output of the supply of air of the electric air moving device to control the speed of the cable based at least in part on the determined speed of the cable.

18. The stringing apparatus of claim 17, wherein the electric air moving device is configured to output (1) a first air supply having a high flow rate and low pressure, and (2) a second air supply having a low flow rate and high pressure.

19. An air moving system for a stringing apparatus, the air moving system comprising:
an air moving device configured to output a supply of air to cause a cable to move along a duct; and
at least one controller configured to:
determine a speed of the cable moving along the duct; and
control the output of the supply of air of the air moving device to control the speed of the cable based at least in part on the determined speed of the cable.

20. The air moving system of claim 19, wherein the air moving device is electrically-driven.
